(19) United States
(12) Patent Application Publication
(10) Pub. No.: US 2026/0340899 A1
(43) Pub. Date: Oct. 29, 2026

(54) INFORMATION PROCESSING APPARATUS AND IMAGE GENERATION METHOD

(71) Applicant: Lenovo (Singapore) Pte. Ltd., Singapore (SG)

(72) Inventors: Yoshinori Ito, Kanagawa (JP); Yuichi Sone, Kanagawa (JP); Kenta Tanii, Kanagawa (JP)

(73) Assignee: Lenovo (Singapore) Pte. Ltd., Singapore (SG)

(21) Appl. No.: 19/387,873

(22) Filed: Nov. 13, 2025

(30) Foreign Application Priority Data
Nov. 14, 2024 (JP) 2024-199139

(51) Int. Cl. G06T 11/60; G06F 40/40

(52) U.S. Cl. CPC G06T 11/60; G06F 40/40

(57) ABSTRACT

An information processing apparatus includes a processor. The processor is configured to acquire data of each of text information input on a sketch image in a superimposed manner and the sketch image. The processor is configured to acquire a generated image generated by an image generation model by inputting input data for image generation based on the sketch image and the text information to the image generation model.

### CROSS-REFERENCE TO RELATED APPLICATIONS

This application claims priority to Japanese Patent Application No. 2024-199139 filed on Nov. 14, 2024, the contents of which are hereby incorporated herein by reference in their entirety.

### TECHNICAL FIELD

The present invention relates to an information processing apparatus and an image generation method.

### BACKGROUND

In recent years, an image generation artificial intelligence (AI) that generates an image from an image such as a hand-drawn sketch (image to image) has been known. In addition, there is also an image generation AI that generates an image by inputting a prompt created using text (text to image) (for example, see Japanese Unexamined Patent Application Publication No. 2024-120131).

Some of the above-described image generation AIs can generate an image by inputting both an image such as a hand-drawn sketch and a prompt, and for example, additional information can be described and designated in the prompt for each part of the sketch so that an image the user wants to create is generated. However, it is necessary to describe the correspondence between the position of each part of the sketch and the prompt in a sentence described in the prompt, and it is not easy and troublesome for the user to express the correspondence accurately (and in a way the image generation AI can understand).

### SUMMARY

According to one or more embodiments, the present disclosure provides an information processing apparatus and an image generation method that improve convenience in a case of using image generation AI.

An information processing apparatus according to one or more embodiments includes a processor configured to acquire data of each of text information input on a sketch image in a superimposed manner and the sketch image, and acquire a generated image generated by an image generation model by inputting input data for image generation based on the sketch image and the text information to the image generation model.

In the information processing apparatus according to one or more embodiments, the processor is further configured to: issue an instruction to generate a prompt as an input sentence for the image generation model by inputting input data for prompt generation based on the sketch image and the text information to a text generation model, and input the prompt generated by the text generation model and the sketch image to the image generation model as the input data for image generation.

In the information processing apparatus according to one or more embodiments the processor is further configured to: receive an input of the sketch image, receive a text input of the text information on the sketch image in a superimposed manner, and output each of the sketch image and the text information as separate pieces of data.

In the information processing apparatus according to one or more embodiments, the processor may receive an input to a first layer, and the processor may receive a text input to a second layer that is superimposed on the first layer.

In the information processing apparatus according to one or more embodiments, the processor is further configured to receive a text input as a prompt to be input to the image generation model, and output a prompt input by a user as a prompt to be added to the prompt generated by the text generation model, and the processor may input the prompt to the image generation model as the prompt to be input to the image generation model.

In the information processing apparatus according to one or more embodiments, the processor is further configured to acquire the prompt generated by the text generation model, present the prompt in a modifiable manner, receive a modification input for the presented prompt, and modify and output the prompt generated by the text generation model based on the modification input, and the processor may input the prompt to the image generation model as a prompt to be input to the image generation model.

In the information processing apparatus according to one or more embodiments, the text generation model may be a vision and language model (VLM).

In addition, an image generation method in an information processing apparatus according to one or more embodiments includes acquiring data of each of text information input on a sketch image in a superimposed manner and the sketch image, and acquiring a generated image generated by an image generation model by inputting input data for image generation based on the sketch image and the text information to the image generation model.

In addition, an image generation method according to one or more embodiments includes: acquiring data of each of text information input on a sketch image in a superimposed manner and the sketch image; and acquiring a generated image generated by an image generation model by inputting input data for image generation based on the sketch image and the text information to the image generation model. In the information processing apparatus according to one or more embodiments, the text generation model is included in a first server, and the image generation model is included in a second server. In the information processing apparatus according to one or more embodiments, the text generation model and the image generation model are included in a server.

According to the embodiments of the present disclosure, it is possible to improve convenience in a case of using image generation AI.

### BRIEF DESCRIPTION OF THE DRAWINGS

FIG. 1 is a diagram illustrating an example of a configuration of an information processing system according to one or more embodiments.

FIG. 2 is a block diagram illustrating an example of a hardware configuration of an information processing apparatus according to one or more embodiments.

FIG. 3 is a diagram illustrating an example of an image generation UI according to one or more embodiments.

FIG. 4 is a diagram illustrating an input example of an input area and an output example of an output area according to one or more embodiments.

FIG. 5 is a block diagram illustrating an example of a functional configuration related to image generation processing according to one or more embodiments.

FIG. 6 is a block diagram illustrating a detailed example of a functional configuration of a UI processing unit according to one or more embodiments.

FIG. 7 is a block diagram illustrating a detailed example of a functional configuration of an image generation processing unit according to one or more embodiments.

FIG. 8 is a flowchart illustrating an example of image generation processing according to one or more embodiments.

### DETAILED DESCRIPTION

Hereinafter, embodiments of the present disclosure will be described with reference to the drawings.

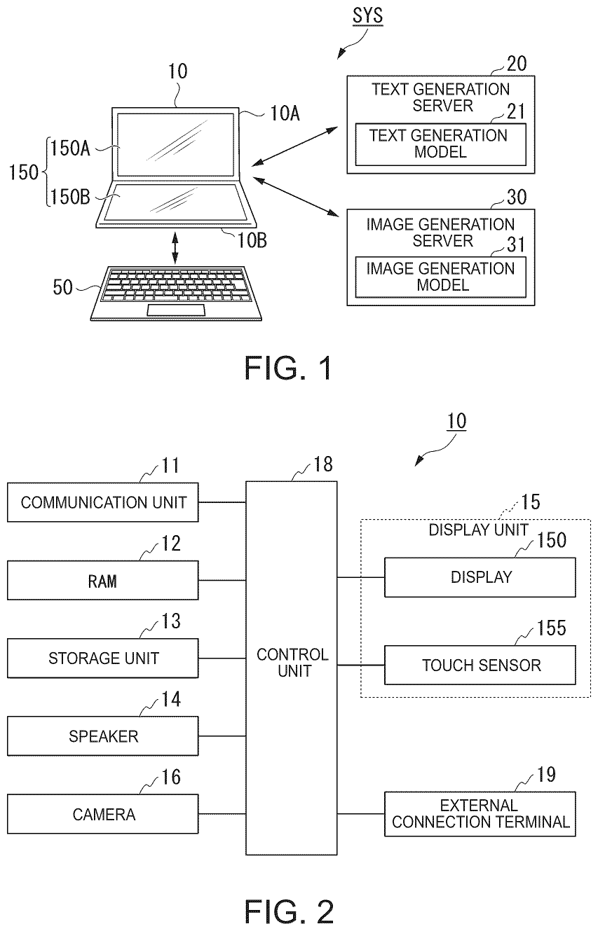

FIG. 1 is a diagram illustrating an example of a configuration of an information processing system according to one or more embodiments. The information processing system SYS includes the information processing apparatus 10, a text generation server 20, and an image generation server 30.

The information processing apparatus 10 is, for example, a clamshell type (laptop) personal computer (PC). In the information processing apparatus 10, a first chassis 10A and a second chassis 10B having a substantially quadrangular plate shape (for example, a flat plate shape) are coupled (connected) to each other via a hinge mechanism to be openable and closable. In addition, the information processing apparatus 10 is provided with a display 150 over the first chassis 10A to the second chassis 10B.

The display 150 is a flexible display that can be bent when the first chassis 10A and the second chassis 10B are opened and closed. As the flexible display, for example, an organic EL display or the like is used. For example, the display 150 can be used not only in a single screen mode in which the entire screen region is used as one screen but also in a two-screen mode in which the entire screen region is divided into two screens of a first screen region 150A on the first chassis 10A side and a second screen region 150B on the second chassis 10B side. For example, when the information processing apparatus 10 is used by being placed on a desk, the second screen region 150B on the second chassis 10B side is a substantially horizontal screen parallel to the surface of the desk.

In addition, a touch sensor is provided on (the surface of) the screen of the display 150. The information processing apparatus 10 can detect a touch operation on a screen region of the display 150. By bringing the information processing apparatus 10 into an open state, the user can visually recognize the display of the display 150 provided on the inner surfaces of each of the first chassis 10A and the second chassis 10B, and can perform a touch operation on the display 150, and thus the information processing apparatus 10 can be used.

In addition, the information processing apparatus 10 can also receive keyboard input by connecting to an external keyboard 50 in a wired or wireless manner.

The text generation server 20 includes a text generation model 21, and generates and outputs text from an input image (or an image and text). The text generation model 21 is, for example, a large-scale vision and language model which is called VLM and the like. That is, the text generation server 20 functions as a text generation artificial intelligence (AI) that generates and outputs text from an image (or an image and text or the like) by using the text generation model 21 as a large-scale vision and language model.

The image generation server 30 may include an image generation model 31. The image generation model 31 is, for example, an image generation model trained using a diffusion model, and generates an image from an input image or a prompt (text). That is, the image generation server 30 functions as an image generation AI that generates and outputs an image from an image and a prompt (text) using the image generation model 31.

The text generation server 20 and the image generation server 30 may be configured as one server or may be configured by being distributed to a plurality of servers.

In one or more embodiments, a text generation AI that generates text using the text generation model 21 and an image generation AI that generates an image using the image generation model 31 are provided in the server. In accordance with one or more embodiments, the information processing apparatus 10 communicates with the server to use the functions of the text generation AI and the image generation AI will be described as an example. However, a configuration may be adopted in which the functions of the text generation AI and the image generation AI are downloaded to the information processing apparatus 10 for local use.

FIG. 2 is a block diagram illustrating an example of a hardware configuration of an information processing apparatus 10 according to one or more embodiments. The information processing apparatus 10 includes a communication unit 11, a random access memory (RAM) 12, a storage unit 13, a speaker 14, a display unit 15, a camera 16, and a control unit 18. Each of these units is connected via a bus or the like in a communicable manner.

The communication unit 11 is configured to include, for example, a plurality of Ethernet (registered trademark) ports, a plurality of digital input and output ports such as universal serial bus (USB), a communication device that performs wireless communication such as Bluetooth (registered trademark) or Wi-Fi (registered trademark), and the like.

For example, the communication unit 11 can communicate with the external keyboard 50 illustrated in FIG. 1, a touch pen, a mouse, a touch pad, or the like, using Bluetooth (registered trademark). In addition, the communication unit 11 can communicate with the text generation server 20 and the image generation server 30 illustrated in FIG. 1 by connecting to the Internet via wireless communication such as Wi-Fi (registered trademark) or wired communication such as Ethernet (registered trademark).

The RAM 12 is a volatile memory in which a program or data of processing executed by the control unit 18 is developed, and various types of data are appropriately stored or deleted. Since the RAM 12 is a volatile memory, the RAM 12 does not hold data when power supply to the RAM 12 is stopped. Data that needs to be held when the power supply to the RAM 12 is stopped is moved to the storage unit 13.

The storage unit 13 is a storage device configured to include any one or a plurality of a solid state drive (SSD), a hard disk drive (HDD), a read only memory (ROM), a flash ROM, or the like. For example, the storage unit 13 stores a program or setting data of a basic input output system (BIOS), a program of an operating system (OS) or an application that operates on the OS, various types of data used in the application, and the like.

The speaker 14 outputs an electronic sound, a voice, or the like.

The display unit 15 includes a display 150 and a touch sensor 155. As described above, according to one or more embodiments, the display 150 is a flexible display that can be bent in accordance with the opening and closing of the first chassis 10A and the second chassis 10B. The display 150 displays a desktop screen of an OS, a window of an application that is being executed, and the like according to the control of the control unit 18.

The touch sensor 155 is provided on a screen of the display 150 and detects a touch operation on the screen. The touch operation includes, for example, a tap operation, a slide operation, a flick operation, a swipe operation, and a pinch operation. In addition, a finger, a touch pen, or the like may be used as an operation section for performing the touch operation.

The camera 16 is configured to include a lens, an imaging element, and the like. The camera 16 captures an image (a still image or a video) and outputs data of the captured image according to the control of the control unit 18.

The control unit 18 is configured to include a processor such as a central processing unit (CPU), a graphic processing unit (GPU), or a microcomputer, and various functions are realized by executing programs (various programs such as a BIOS, an OS, and applications that operate on the OS) stored in the storage unit 13 and the like. For example, the control unit 18 controls a screen mode of the display 150, controls display in a screen region, and detects a touch operation on the touch sensor 155.

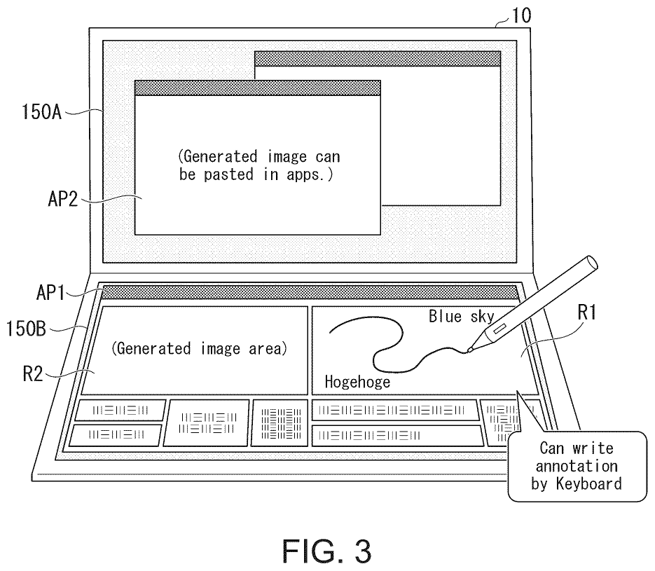

Next, the image generation processing using the image generation model 31 (image generation AI) in the information processing apparatus 10 will be described in accordance with one or more embodiments. First, a user interface (UI) will be described with reference to FIG. 3.

FIG. 3 is a diagram illustrating an example of an image generation UI according to one or more embodiments. In the example illustrated in the drawing, the information processing apparatus 10 controls the display 150 in a two-screen mode of the first screen region 150A and the second screen region 150B. In the second screen region 150B, a window of an application AP1 (hereinafter, referred to as an “image generation application AP1”) having an image generation function of generating an image using the image generation model 31 (image generation AI) is displayed. The window of the image generation application AP1 has an input area R1 for inputting information on the image to be generated and an output area R2 for displaying the generated image as a UI.

The user can input a sketch to the input area R1 by hand and can input an annotation as additional information in text on the sketch in a superimposed manner. The additional information is information for supplementing each part of the sketch, information on an object not included in the sketch, and the like. The annotation can be input to any location on the sketch.

Since the second screen region 150B is a substantially horizontal screen when the information processing apparatus 10 is used by being placed on a desk, the user can easily perform input because the input area R1 is present on the second screen region 150B side.

When the user inputs the sketch by hand, the user can mainly use a touch pen, but the user may use a finger without using the touch pen, may use an external mouse (not illustrated), or may use an external touch pad (not illustrated). In addition, when the user inputs the annotation in text, the user can input the annotation by using, for example, a keyboard (see FIG. 1), but can also input the annotation by using an on-screen display software keyboard or by hand by using a touch pen or the like.

It should be noted that the UI for image generation illustrated in FIG. 3 is an example, and the UI for image generation in the present disclosure (including the positioning and size of the input area R1 and the output area R2, the screen regions where the input area R1 and the output area R2 are displayed, and the like) is not limited to this example.

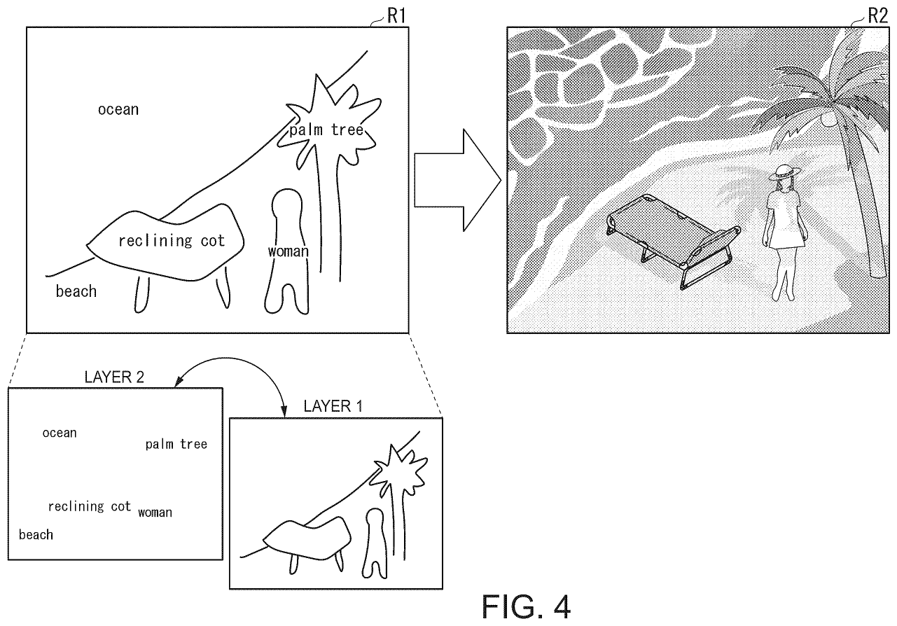

FIG. 4 is a diagram illustrating an input example of an input area R1 and an output example of an output area R2 according to the one or more embodiments. FIG. 4 illustrates an input example to the input area R1. As described above, in the input area R1, the hand-drawn input of the sketch and the text input of the annotation are possible.

For example, the image generation application AP1 has a plurality of layers that is superimposed on each other in a range of the input area R1 as inputtable regions, and switches between a layer 1 that receives the hand-drawn input of the sketch and a layer 2 that receives the text input of the annotation to receive each input. That is, the user selects the layer 1 for input in a case of inputting the sketch by hand, and selects the layer 2 for input in a case of inputting the annotation in text. As a result, for example, after selecting the layer 1 to input a sketch by hand, the user can select the layer 2 to input the annotation on the sketch image input to the layer 1 in a superimposed manner.

In the input example illustrated in FIG. 4, “tree”, “person”, “furniture with legs”, and “diagonal line” from the upper right to the lower left in the input area R1 are input by hand as a sketch to the layer 1. In addition, “palm tree” is input at the position of “tree” in the sketch, “woman” is input at the position of the “person” in the sketch, and “reclining cot” is input at the position of “furniture with legs” in the sketch, and “ocean” is input on the upper side and “beach” is input on the lower side of the portion divided by “diagonal line” in the sketch as the annotation in text to the layer 2, in a superimposed manner on the sketch image input to the layer 1.

The image generation application AP1 generates each of data of the sketch image input to the layer 1 and data of the annotation input to the layer 2 as separate pieces of data. The image generation application AP1 may acquire the data of the sketch image from a file of image data, not limited to the input to the layer 1. That is, the image generation application AP1 may display a part or all of the loaded image data on the layer 1 as the sketch image by loading the image data from the file. As a result, the user can input the annotation on the sketch image displayed on the layer 1 in a superimposed manner, for example.

The image generation application AP1 acquires a generated image generated by the image generation model 31 by inputting input data based on the sketch image and the annotation to the image generation model 31. Then, the image generation application AP1 displays the acquired generated image in the output area R2. FIG. 4 illustrates an example of the generated image displayed in the output area R2 as an output example of the output area R2. The generated image illustrated in this drawing is an image diagram drawn by imitating the generated image generated by the image generation model 31. In the example of the generated image illustrated in R2 of FIG. 4, an image in which a palm tree, a woman, and a reclining bed are positioned on a coastal beach is generated according to the input example illustrated in R1 of FIG. 4.

Returning to FIG. 3, a window of another application AP2 different from the image generation application AP1 is displayed in the first screen region 150A. The generated image generated by the image generation application AP1 can also be used in other applications, and for example, the generated image can be copied and pasted and displayed in a window of the other application AP2. The other application AP2 is, for example, an application that is capable of inserting or pasting an image, such as an application having a presentation creation function, an application having a document creation function, or an application having an image editing function.

Next, a functional configuration of the image generation processing realized by the control unit 18 executing the image generation application AP1 will be described according to one or more embodiments.

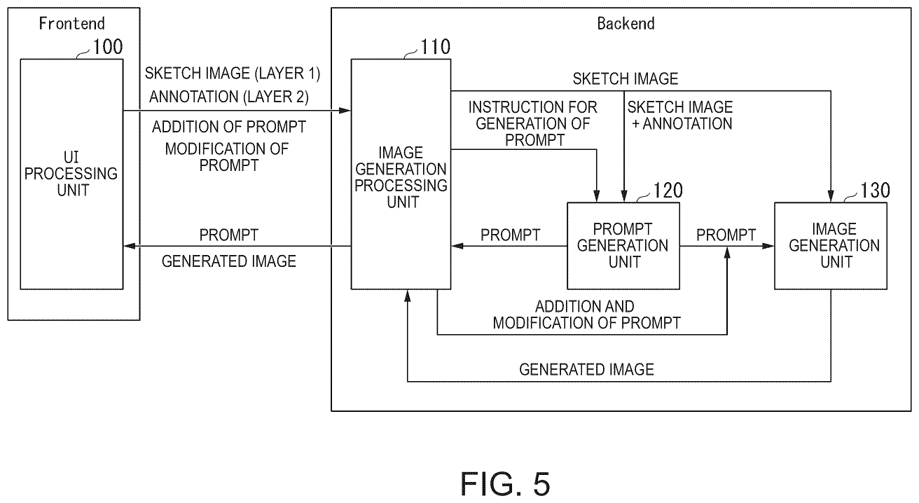

FIG. 5 is a block diagram illustrating an example of a functional configuration related to image generation processing according to one or more embodiments. In this drawing, a frontend configuration related to the UI of the image generation application AP1 described with reference to FIG. 4 and a backend configuration for generating an image according to the processing are illustrated.

As the frontend configuration, the UI processing unit 100 is provided as a functional configuration by the UI described with reference to FIG. 4. The UI processing unit 100 outputs each data of the sketch image and the annotation input to the input area R1 (see FIG. 3) by the user, to the backend. In addition, the UI processing unit 100 outputs the generated image acquired from the backend to the output area R2.

The backend configuration includes an image generation processing unit 110, a prompt generation unit 120, and an image generation unit 130.

The prompt generation unit 120 corresponds to a functional configuration of the text generation server 20 illustrated in FIG. 1, and generates and outputs a prompt (text) from the input image (or the image and the text) by using the text generation model 21. The image generation unit 130 corresponds to a functional configuration of the image generation server 30 illustrated in FIG. 1, and generates and outputs an image from the input image and prompt (text) by using the image generation model 31.

The image generation processing unit 110 connects the UI processing unit 100 of the frontend, and the prompt generation unit 120 and the image generation unit 130 of the backend, and executes the image generation processing by using the prompt generation unit 120 and the image generation unit 130 based on the data acquired from the UI processing unit 100.

The image generation processing unit 110 may have a functional configuration realized in the control unit 18 by the control unit 18 executing the image generation application AP1, or may have a functional configuration on the server side.

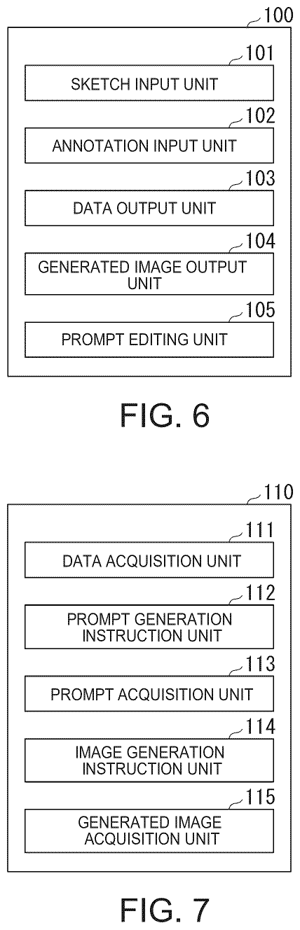

Hereinafter, image generation processing according to one or more embodiments will be described in detail with reference to FIGS. 5-7. FIG. 6 is a block diagram illustrating a detailed example of a functional configuration of a UI processing unit 100 according to one or more embodiments. The UI processing unit 100 includes a sketch input unit 101, an annotation input unit 102 (an example of a text input unit), a data output unit 103, a generated image output unit 104, and a prompt editing unit 105.

The sketch input unit 101 receives a hand-drawn input of a sketch (sketch image) by the user. For example, the sketch input unit 101 receives the hand-drawn input of the sketch image by the hand-drawn input to the layer 1 (see FIGS. 3 and 4) of the input area R1.

The annotation input unit 102 receives the text input of the annotation by the user on the sketch image received by the sketch input unit 101 in a superimposed manner. For example, the annotation input unit 102 receives the text input of the annotation from the text input to the layer 2 (see FIGS. 3 and 4) that is superimposed on the layer 1 of the input area R1.

The data output unit 103 outputs each of the sketch image received by the sketch input unit 101 and the annotation received by the annotation input unit 102 as separate pieces of data.

The generated image output unit 104 acquires and outputs the generated image output from the image generation unit 130 via the image generation processing unit 110. For example, the generated image output unit 104 displays the acquired generated image in the output area R2 (see FIG. 3).

The prompt editing unit 105 receives a text input as a prompt by the user, and outputs the prompt input by the user as a prompt to be added to the prompt generated by the prompt generation unit 120.

In addition, the prompt editing unit 105 acquires the prompt generated by the prompt generation unit 120, presents (displays) the prompt in a modifiable manner, and receives modification input for the prompt. Then, the prompt editing unit 105 modifies the prompt generated by the prompt generation unit 120 based on the modification input and outputs the modified prompt.

FIG. 7 is a block diagram illustrating a detailed example of a functional configuration of an image generation processing unit 110 according to one or more embodiments. The image generation processing unit 110 includes a data acquisition unit 111, a prompt generation instruction unit 112, a prompt acquisition unit 113, an image generation instruction unit 114, and a generated image acquisition unit 115.

The data acquisition unit 111 acquires the data of the sketch image and the data of the annotation input on the sketch image in a superimposed manner from the UI processing unit 100.

The prompt generation instruction unit 112 instructs the prompt generation unit 120 to generate a prompt as an input sentence for the image generation unit 130 (image generation model 31) by inputting input data for prompt generation based on the sketch image and the annotation acquired by the data acquisition unit 111 to the prompt generation unit 120. For example, the input data for prompt generation is data of an image obtained by integrating a layer of a sketch image and a layer of an annotation.

Here, the prompt for text generation input to the prompt generation unit 120 (text generation model 21) when the prompt generation instruction unit 112 inputs the input data for prompt generation to the prompt generation unit 120 is an instruction for causing the text generation model 21 to generate a prompt (prompt for image generation) input to the image generation unit 130 (image generation model 31). For example, the prompt generation instruction unit 112 inputs a prompt for generating a text of an instruction such as “generate a prompt including the position information of the object in a predetermined format” to the prompt generation unit 120 (text generation model 21).

A plurality of prompts for text generation may be prepared in advance according to the image to be generated by using the image generation unit 130 (image generation model 31), and one of the plurality of prompts for text generation may be selected.

When the input data for prompt generation is input, the prompt generation unit 120 generates and outputs a prompt (prompt for image generation) to be input to the image generation unit 130 by using the text generation model 21.

The prompt acquisition unit 113 acquires the prompt generated by the prompt generation unit 120 from the prompt generation unit 120. In addition, the prompt acquisition unit 113 outputs the acquired prompt to the UI processing unit 100. When the user adds a prompt to the prompt generated by the prompt generation unit 120 in the UI processing unit 100, or modifies the prompt, the prompt acquisition unit 113 acquires the prompt output by the prompt editing unit 105 of the UI processing unit 100.

When there is no addition or modification to the prompt generated by the prompt generation unit 120, the prompt acquisition unit 113 outputs the prompt acquired from the prompt generation unit 120 to the image generation instruction unit 114. On the other hand, when there is addition or modification to the prompt generated by the prompt generation unit 120, the prompt acquisition unit 113 outputs the prompt acquired from the prompt editing unit 105 of the UI processing unit 100 to the image generation instruction unit 114.

The image generation instruction unit 114 instructs the image generation unit 130 to generate an image by inputting the prompt acquired from the prompt acquisition unit 113 and the sketch image acquired by the data acquisition unit 111 to the image generation unit 130 as the input data for image generation.

That is, in a case where there is no addition or modification to the prompt generated by the prompt generation unit 120, the image generation instruction unit 114 inputs the prompt generated by the prompt generation unit 120 and the sketch image acquired by the data acquisition unit 111 to the image generation unit 130. On the other hand, in a case where there is addition or modification to the prompt generated by the prompt generation unit 120, the prompt generated by the prompt generation unit 120 to which there is addition or modification and the sketch image acquired by the data acquisition unit 111 are input to the image generation unit 130.

When the prompt and the sketch image are input, the image generation unit 130 generates an image using the image generation model 31 and outputs the generated image.

The generated image acquisition unit 115 acquires the generated image generated by the image generation unit 130. In addition, the generated image acquisition unit 115 outputs the acquired generated image to the UI processing unit 100.

Next, an operation of the image generation processing executed by the image generation processing unit 110 will be described according to one or more embodiments.

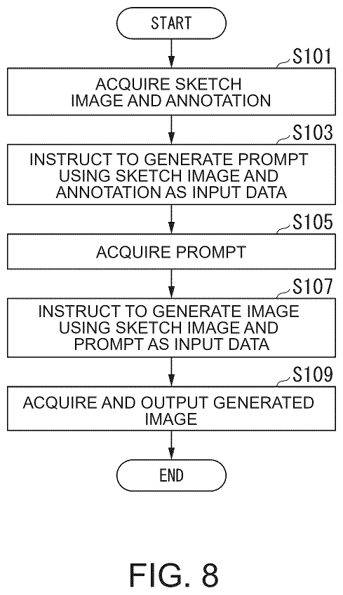

FIG. 8 is a flowchart illustrating an example of image generation processing according to one or more embodiments.

(Step S101) The image generation processing unit 110 acquires the data of the sketch image and the data of the annotation input on the sketch image in a superimposed manner from the UI processing unit 100 based on the hand-drawn input and the text input of the user for the input area R1 illustrated in FIG. 3. Then, the process proceeds to the processing of step S103.

(Step S103) The image generation processing unit 110 instructs the prompt generation unit 120 to generate a prompt to be input to the image generation unit 130 (image generation model) by inputting the input data for prompt generation based on the sketch image and the annotation acquired in step S101 to the prompt generation unit 120. For example, the image generation processing unit 110 inputs data of an image obtained by integrating the layer of the sketch image and the layer of the annotation to the prompt generation unit 120 as the input data for prompt generation. Then, the process proceeds to the processing of step S105.

(Step S105) The image generation processing unit 110 acquires the prompt generated by the prompt generation unit 120. In addition, the image generation processing unit 110 outputs the acquired prompt to the UI processing unit 100, and in a case where the user adds or modifies the prompt in the UI processing unit 100, the image generation processing unit 110 acquires the added or modified prompt from the UI processing unit 100. (Step S107) The image generation processing unit 110 instructs the image generation unit 130 to generate an image by inputting the sketch image acquired in step S101 and the prompt acquired in step S105 to the image generation unit 130 as the input data for image generation.

(Step S109) The image generation processing unit 110 acquires the generated image generated by the image generation unit 130 and outputs the acquired generated image to the UI processing unit 100. The UI processing unit 100 displays the acquired generated image in an output area R2 (see FIG. 3).

As described above, the information processing apparatus 10 according to one or more embodiments acquires the data of each of the annotation (an example of the text information) input on the sketch image in a superimposed manner, and the sketch image, and inputs the input data for image generation based on the sketch image and the annotation to the image generation model 31. Then, the information processing apparatus 10 acquires the generated image generated by the image generation model 31.

As a result, the information processing apparatus 10 can generate an image in which information for supplementing each part of the sketch and information on an object not included in the sketch are easily added by the user simply inputting the annotation on the sketch image in a superimposed manner. Therefore, it is not necessary to describe the correspondence between the annotation and the position of each part of the sketch in a sentence, and the convenience in a case of using the image generation AI can be improved.

For example, the information processing apparatus 10 issues an instruction to generate a prompt as an input sentence for the image generation model 31 by inputting the input data for prompt generation based on the acquired sketch image and annotation to the text generation model 21. Then, the information processing apparatus 10 inputs the prompt generated by the text generation model 21 and the sketch image to the image generation model 31 as the input data for image generation. Here, the input data for prompt generation is, for example, data of an image obtained by integrating a layer of a sketch image and a layer of an annotation.

As a result, the information processing apparatus 10 can generate a prompt in which the annotation and the position of each part of the sketch correspond to each other by the user simply inputting the annotation on the sketch image in a superimposed manner and input to the image generation model 31. Therefore, it is not necessary to describe the correspondence between the annotation and the position of each part of the sketch in a sentence, and the convenience in a case of using the image generation AI can be improved.

In addition, the information processing apparatus 10 receives the input of the sketch image and receives the text input of the annotation on the received sketch image in a superimposed manner. Then, the information processing apparatus 10 outputs each of the sketch image and the annotation as separate pieces of data.

As a result, the information processing apparatus 10 handles the sketch image and the annotation as independent data, respectively, and thus, it is not necessary to separate the sketch image and the annotation later. In addition, since the information processing apparatus 10 handles the sketch image and the annotation as independent data, respectively, it is also possible to store only the sketch image or only the annotation. In addition, since the information processing apparatus 10 handles the sketch image and the annotation as independent data, respectively, it is possible to independently perform a function of “Undo” that returns to a state before the immediately preceding operation, and a function of “Redo” that returns to a state before Undo from the Undo state.

For example, the information processing apparatus 10 receives an input for a layer 1 (first layer) and a text input for a layer 2 (second layer) that is superimposed on the layer 1.

As a result, the information processing apparatus 10 can handle the sketch image and the annotation as independent data, respectively, by managing the sketch image and the annotation in separate layers.

In addition, the information processing apparatus 10 receives a text input as a prompt to be input to the image generation model 31, and outputs the prompt input by the user as a prompt to be added to the prompt generated by the text generation model 21. Then, the information processing apparatus 10 inputs the output prompt to the image generation model 31 as a prompt to be input to the image generation model 31.

As a result, in the information processing apparatus 10, the user can add a prompt to the prompt generated from the sketch image and the annotation, and input the prompt to the image generation model 31, so that the user can adjust the content of the prompt.

In addition, the information processing apparatus 10 acquires the prompt generated by the text generation model 21, presents the prompt in a modifiable manner, receives the modification input for the presented prompt, and modifies and outputs the prompt generated by the text generation model 21 based on the modification input. Then, the information processing apparatus 10 inputs the output prompt to the image generation model 31 as a prompt to be input to the image generation model 31.

As a result, in the information processing apparatus 10, the user can modify the prompt generated from the sketch image and the annotation and input the prompt to the image generation model 31, so that the user can adjust the content of the prompt.

In addition, the information processing apparatus 10 generates a prompt using a vision and language model (VLM) as the text generation model 21.

As a result, the information processing apparatus 10 can automatically generate a prompt in which the input annotation corresponds to the position of each part of the sketch, by using the text generation AI, by the user simply inputting the annotation on the sketch image in a superimposed manner.

In addition, the image generation method in the information processing apparatus 10 may include a step of acquiring data of each of the annotation (an example of text information) input on a sketch image in a superimposed manner and the sketch image, and a step of acquiring a generated image generated by the image generation model 31 by inputting the input data for image generation based on the sketch image and the annotation to the image generation model 31, via the control unit 18 (image generation processing unit 110).

As a result, in the image generation method in the information processing apparatus 10, an image in which information for supplementing each part of the sketch and information on an object not included in the sketch are easily added can be generated by the user simply inputting the annotation on the sketch image in a superimposed manner. Therefore, it is not necessary to describe the correspondence between the annotation and the position of each part of the sketch in a sentence, and the convenience in a case of using the image generation AI can be improved.

Although embodiments of the present disclosure have been described in detail with reference to the drawings, the specific configuration is not limited to the above-described embodiments, and designs and the like within a range not departing from the scope of the present disclosure are also included. For example, each configuration described in the above-described embodiments can be freely combined with each other.

In the above-described embodiments, an example in which the data of the image obtained by integrating the layer of the sketch image and the layer of the annotation is input to the prompt generation unit 120 (text generation model 21) as the input data for prompt generation has been described. However, in one or more other embodiments, the prompt (text information) may be generated by inputting the data of the sketch image and the data of the annotation (image of the annotation) without integrating the layer of the sketch image and the layer of the annotation.

In the above-described embodiments, an example in which the user can edit the prompt (prompt for image generation) generated by the text generation model 21 has been described, but, in one or more other embodiments, the user may also edit the prompt for text generation to be input to the text generation model 21.

In addition, in the above-described embodiments, the example in which the display 150 is one display provided over the first chassis 10A and the second chassis 10B has been described, but the present disclosure is not limited to this. For example, in one or more other embodiments, the information processing apparatus 10 may be provided with two displays, one for each of the first chassis 10A and the second chassis 10B. In addition, the information processing apparatus 10 may be provided with a display only in one of the first chassis 10A and the second chassis 10B (for example, only the first chassis 10A).

In addition, the information processing apparatus 10 is not limited to a clamshell type (laptop) PC, and may be, for example, a tablet type PC or a desktop type PC in accordance with one or more embodiments.

In addition, in the above-described embodiments, an example of a touch panel type display in which the input unit (touch sensor) and the display unit (display) are integrated has been described, but a non-touch panel type display that does not have the input unit (touch sensor) may be used in accordance with one or more other embodiments. In that case, for example, a touch pad, a mouse, or the like may be used as the input device that receives the operation instead of the input unit (touch sensor).

In addition, for example, the image generation model 31 may also include a text generation function by the text generation model 21, and the image may be generated by inputting the sketch image and the annotation to the image generation model 31.

The information processing apparatus 10 described above has a computer system inside. A program for realizing the functions of each configuration included in the information processing apparatus 10 described above may be recorded on a computer-readable recording medium, and the program recorded on the recording medium may be loaded into the computer system and executed to perform the processing in each configuration included in the information processing apparatus 10 described above. Here, “loading the program recorded on the recording medium into the computer system and executing” includes installing the program in the computer system. The “computer system” referred to here includes hardware such as an OS and peripheral devices. In addition, the “computer system” may include a plurality of computer devices connected via a network including a communication line such as the Internet, a WAN, a LAN, or a dedicated line. In addition, the “computer-readable recording medium” refers to a storage device such as a portable medium such as a flexible disk, a magneto-optical disk, a ROM, or a CD-ROM, or a hard disk built in a computer system. As described above, the recording medium in which the program is stored may be a non-transitory recording medium such as a CD-ROM.

In addition, the recording medium also includes a recording medium which is provided internally or externally and accessible from a distribution server to distribute the program. It should be noted that a configuration in which after the program is divided into a plurality of parts and each of the parts is downloaded at different timings, the program is combined into each configuration included in the information processing apparatus 10, or a distribution server that distributes each of the divided programs may be different. Further, the “computer-readable recording medium” includes a recording medium that holds a program for a certain period of time, such as a volatile memory (RAM) inside a computer system serving as a server or a client in a case where a program is transmitted via a network. In addition, the program may be a program for realizing a part of the above-described functions. Furthermore, the above-described functions may be realized in combination with a program already recorded in the computer system, which is a so-called difference file (difference program).

In addition, a part or all of the functions provided in the information processing apparatus 10 in the above-described embodiments may be realized as an integrated circuit such as a large scale integration (LSI). Each function may be individually processed, or a part or all of the functions may be integrated and processed. In addition, the method of integrating the circuits is not limited to LSI, and may be realized by a dedicated circuit or a general-purpose processor. In addition, in a case where a technique of integrating a circuit has appeared as a substitute for LSI due to the advancement of semiconductor technology, an integrated circuit using the technique may be used according to one or more embodiments.

### DESCRIPTION OF SYMBOLS

10 information processing apparatus
10A first chassis
10B Second chassis
20 text generation server
21 text generation model
30 image generation server
31 image generation model
11 communication unit
12 RAM
13 storage unit
14 speaker
15 display unit
16 camera
150 display
150A first screen region
150B second screen region
155 touch sensor
18 control unit
100 UI processing unit
101 sketch input unit
102 annotation input unit
103 data output unit
104 generated image output unit
105 prompt editing unit
110 image generation processing unit
111 data acquisition unit
112 prompt generation instruction unit
113 prompt acquisition unit
114 image generation instruction unit
115 generated image acquisition unit
120 prompt generation unit
130 image generation unit
SYS information processing system

What is claimed is:

1. An information processing apparatus comprising a processor, the processor configured to:
acquire data of each of text information input on a sketch image in a superimposed manner and the sketch image; and
acquire a generated image generated by an image generation model by inputting input data for image generation based on the sketch image and the text information to the image generation model.

2. The information processing apparatus according to claim 1, wherein the processor is further configured to:
issue an instruction to generate a prompt as an input sentence for the image generation model by inputting input data for prompt generation based on the sketch image and the text information to a text generation model; and
input the prompt generated by the text generation model and the sketch image to the image generation model as the input data for image generation.

3. The information processing apparatus according to claim 1, wherein the processor is further configured to:
receive an input of the sketch image;
receive a text input of the text information on the sketch image in a superimposed manner; and
output each of the sketch image and the text information as separate pieces of data.

4. The information processing apparatus according to claim 3,
wherein the processor receives an input to a first layer, and
the processor is further configured to receive a text input to a second layer that is superimposed on the first layer.

5. The information processing apparatus according to claim 2, wherein the processor is further configured to receive a text input as a prompt to be input to the image generation model, and output a prompt input by a user as a prompt to be added to the prompt generated by the text generation model,
wherein the processor is further configured to inputs the prompt to the image generation model as the prompt to be input to the image generation model.

6. The information processing apparatus according to claim 2, wherein the processor is further configured to acquire the prompt generated by the text generation model, present the prompt in a modifiable manner, receive a modification input for the presented prompt, and modify and output the prompt generated by the text generation model based on the modification input,
wherein the processor is further configured to input the prompt to the image generation model as a prompt to be input to the image generation model.

7. The information processing apparatus according to claim 2,
wherein the text generation model generates the prompt using a vision and language model (VLM).

8. An image generation method in an information processing apparatus, the method comprising:
acquiring data of each of text information input on a sketch image in a superimposed manner and the sketch image; and
acquiring a generated image generated by an image generation model by inputting input data for image generation based on the sketch image and the text information to the image generation model.

9. An image generation method, the method comprising:
acquiring data of each of text information input on a sketch image in a superimposed manner and the sketch image; and
acquiring a generated image generated by an image generation model by inputting input data for image generation based on the sketch image and the text information to the image generation model.

10. The information processing apparatus according to claim 2, wherein the text generation model is included in a first server, and the image generation model is included in a second server.

11. The information processing apparatus according to claim 2, wherein the text generation model and the image generation model are included in a server.
